(19) United States
(12) Patent Application Publication
(10) Pub. No.: US 2024/0365771 A1
(43) Pub. Date: Nov. 7, 2024

(54) PORTABLE ACCESSORY COMPRISING A CASE FOR RECEIVING A PAD CONTAINING A VOLATILE ACTIVE SUBSTANCE

(71) Applicant: EVERGREEN LAND LIMITED, Hong Kong (CN)

(72) Inventor: Olivier Partrat, Hong Kong (CN)

(21) Appl. No.: 18/572,693

(22) PCT Filed: Jun. 21, 2022
(86) PCT No.: PCT/IB2022/055736

§ 371 Date: Dec. 20, 2023

(30) Foreign Application Priority Data
Jun. 21, 2021 (FR) FR2106592

(51) Int. Cl. A01M 29/12; A44C 5/00; A45F 5/00

(52) U.S. Cl. CPC A01M 29/12; A44C 5/003; A45F 5/00; A45F 2005/008

(57) ABSTRACT

An accessory intended to be worn by a user, including a case and an element for carrying the case, the accessory also including a pad that is able to release an active substance by gradual evaporation, the case being equipped with a housing that has a lateral slot through which the pad can be reversibly inserted, the housing being arranged for providing a force for holding said inserted pad, at least one wall of the housing having a grille the openings of which are arranged to allow the evaporation of the active substance through the grille.

The invention relates to an accessory intended to be worn by a user, said accessory comprising in particular a pad that is able to release an active substance by gradual evaporation.

It applies in particular to an accessory the pad of which contains a volatile active substance that has a repellent function for harmful insects such as stinging or biting haematophagous insects, for example mosquitoes, a perfuming and/or aromatherapeutic function.

Such a pad is known from the document EP-1 919 279, comprising a matrix made from polymer material wherein a liquid composition is impregnated, said liquid composition advantageously comprising a mixture between:
an active substance based on an essential oil or on a mixture of essential oils;
a solute comprising at least one food substance selected from vanillin and a mixture of vanillin and menthol carboxamide, said solute being able to reduce the evaporation kinetics of the active substance by reducing the vapour pressure, in order to increase the duration of diffusion of said active substance.

Accessories are known that comprise a bracelet for wearing by the user, in particular intended to be attached around his wrist and/or on a support carried by the user, for example a backpack, a handbag or a belt, the pad being associated permanently or reversibly with said bracelet.

Bracelets are known in particular produced from a flexible material on which a housing is formed for the removable reception of a pad, in particular with a view to subsequent replacement thereof after evaporation of all or part of the active substance.

In particular, the housing is formed by attaching to the main body of the bracelet a perforated textile piece, for example made from a textile material of the mesh type, by partial stitching of the edges of said textile piece to said main body, one edge of said piece being left free of stitching to enable the pad to be inserted.

This solution makes it possible to diffuse the active substance contained in the pad through the meshes of the textile piece, without however preventing the possibility of contact of the pad by the user through the perforated textile piece.

Moreover, this solution is not entirely satisfactory in that it does not make it possible to hold the pad on the bracelet in a satisfactory manner, or allow an easy removal of said pad after use. Furthermore, because of the flexibility of the bracelet and of the housing, the risk of deformation and degradation of the pad remains high, which does not guarantee for the user optimum efficacy of the accessory. Furthermore, this solution is not versatile in that it does not make it possible to separate the housing from the bracelet, for example for replacing said bracelet for aesthetic purposes or in the case of damage.

The invention aims to improve the prior art by proposing in particular an accessory wherein the pad is protected, held and replaceable in an improved manner, while guaranteeing optimum release gradually of the active substance throughout the whole service life of said pad.

For this purpose, the invention proposes an accessory intended to be worn by a user, said accessory comprising a case and an element for carrying said case, said accessory furthermore comprising a pad that is able to release an active substance by gradual evaporation, the case being equipped with a housing that has a lateral slot through which said pad can be reversibly inserted, said housing being arranged to provide a force for holding said inserted pad, at least one wall of said housing having a grille, the openings of which are arranged to allow the evaporation of the active substance through said grille.

Other particularities and advantages of the invention will emerge in the following description, made with reference to the accompanying figures, wherein:

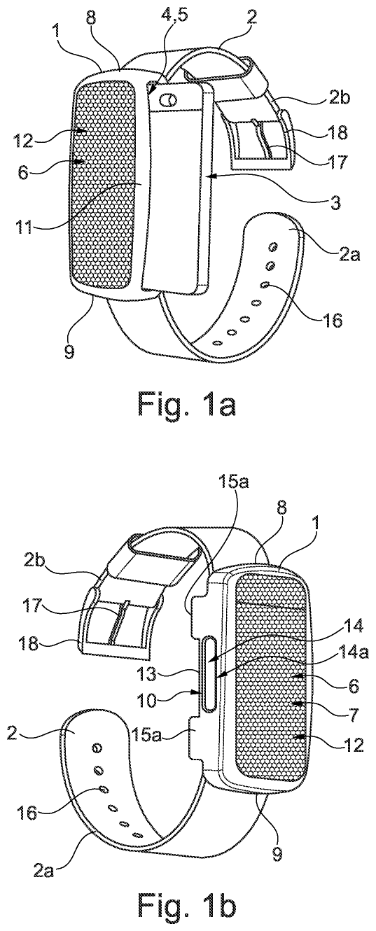

FIG. 1a and

FIG. 1b shows schematically and in perspective an accessory according to one embodiment of the invention, respectively during the insertion of a pad in the housing (FIG. 1a) and with said pad inserted in said housing (FIG. 1b);

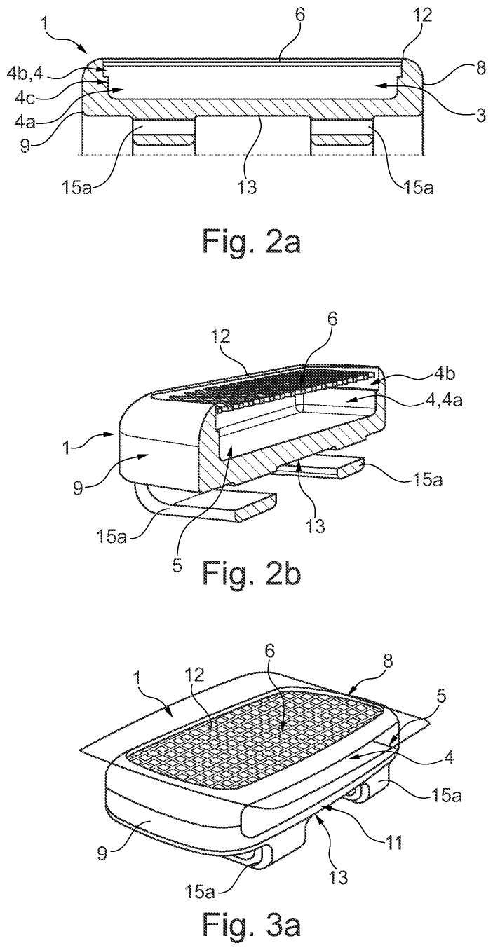

FIG. 2a and

FIG. 2b show schematically and in longitudinal section the case of the accessory of FIGS. 1a and 1b, respectively in a view according to a lateral face (FIG. 2a) and in perspective (FIG. 2b);

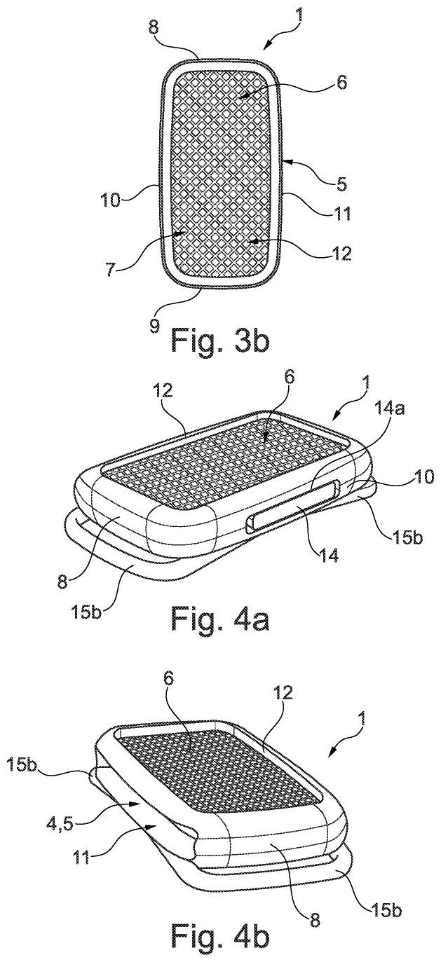

FIG. 3a and

FIG. 3b show schematically a case according to a variant embodiment of the previous figures, respectively in perspective (FIG. 3a) and in top view (FIG. 3b);

FIG. 4a and

FIG. 4b show schematically and in perspective a case according to another embodiment of the invention.

In relation to these figures, a description is given below of an accessory intended to be worn by a user, said accessory comprising a case 1 and an element for carrying said case that is in the form of a bracelet 2, as well as a pad 3 that is able to release an active substance by gradual evaporation.

In the description, the terms for positioning in space are taken with reference to the case 1 as shown on the figures, in particular:
the terms “top” and “bottom” are taken with reference to FIG. 2a;
the terms “front”, “rear”, “left” and “right” are taken with reference to FIG. 3b, the terms “front” and “rear” referring to positions respectively at the top and at the bottom on this same figure.

The accessory may in particular comprise a pad 3 as described in the document EP-1 919 279, which comprises a matrix of polymer material wherein a liquid composition comprising the active substance is impregnated.

In particular, the active substance can have at least one function selected from the following functions:
a repellent function for harmful animals, such as stinging or biting haematophagous insects, for example mosquitoes; and/or
a perfuming function; and/or
an aromatherapeutic function.

Advantageously, as taught by the document EP 1 919 279, the liquid composition may comprise:
an active substance comprising an essential oil or a mixture of essential oils;
a solute comprising at least one food substance selected from vanillin and a mixture of vanillin and menthol carboxamide, said solute being able to reduce the evaporation kinetics of the active substance by reducing the vapour pressure.

The case 1 is equipped with a housing 4 that has a lateral slot 5 through which the pad 3 can be reversibly inserted, said housing being arranged to provide a force for holding said inserted pad, at least one wall of said housing having a grille 6 the openings 7 of which are arranged to allow the evaporation of the active substance and diffusion thereof through said grille.

The case 1 has a structure that allows to ensure good holding of the pad 3 in the housing, while also preventing said pad from deforming when the bracelet 2 is attached around a part of the body of the user and/or on a support carried by said user, for example a backpack. In a variant, the carrying element can be in the form of an element for attaching to a support, for example a quick-release buckle, which is associated with the case 1, or an ankle bracelet, an element for carrying on clothes, flip-flops, necklaces, bags, etc.

The case 1 makes it possible to avoid direct contact between the pad 3 and the support on which the accessory is carried, which makes it possible:
to protect the pad 3 against risks of degradation by rubbing, in particular when the accessory is carried on a support carried by the user, such as a backpack, a handbag or a belt;
to limit the risks of irritation and/or allergy for the user, when the bracelet 2 is attached around their wrist.

Advantageously, the housing 4 is elastically deformable by insertion of the pad 3, said deformation being arranged so that said housing applies to said pad a clamping force that is sufficient to hold said pad.

In particular, the dimension of the slot 5 is similar to that of the pad 3, in order to limit the risk of faulty insertion of said pad in the housing 4 and, in relation to the clamping applied by said housing, to secure the use of the accessory with regard to the risk of removal of said pad by young children.

As shown on FIG. 2a, the housing 4 has edges 4c that are arranged to provide a lateral holding of the pad 4 between said edges. For this purpose, the housing 4 has a bottom part 4a that forms a cavity with a geometry complementary to that of the periphery of the pad 3, in order to hug said periphery when said pad is arranged in the housing 4.

In particular, the housing 4 has a top part 4b that extends between the bottom part 4a and the grille 6, while having a height that is sufficient for keeping the pad 3 at a distance from said grille. This arrangement allows to improve the circulation of air at the top face of the pad 3, and thus guarantees good evaporation of the active substance of said pad.

To obtain the aforementioned properties and advantages, the case 1 can be produced from an elastomer material, which also facilitates manufacture thereof, in particular by moulding, and therefore reduces the production costs of the accessory.

In the embodiments shown, the case 1 has a parallelepipedal geometry with rounded edges, the housing 4 being formed between four lateral faces, respectively front 8-rear 9 and left 10-right 11, and two faces respectively top 12 and bottom 13, the respective dimensions of said faces being in particular defined so as to enable the case to be worn on the wrist of the wearer.

In particular, the top 12 and bottom 13 faces have a rectangular shape with rounded edges, the front 8-rear 9 lateral faces having a size less than that of the left 10-right 11 lateral faces.

One of the lateral faces 8, 9, 10, 11 has a slot 5 for inserting the pad 3 in the housing 4, which makes it possible to easily locate said slot for inserting a pad 3 therein, in particular with a view to replacing a pad at the end of life after evaporation of all or part of the active substance.

Advantageously, the slot 5 is formed on one of the left 10-right 11 lateral faces, and has a great length and/or height, in particular equal to at least 80% of the total length and/or width of said face. This arrangement facilitates the insertion and extraction of a pad 3 into and from the housing 4.

Moreover, the lateral face 10 opposite to the slot 5 has a button 14 making it possible to push the pad 3 out of the housing 4 with a view to removal thereof. On the figures, the slot 5 and the button 14 are formed on the lateral faces respectively right 11 and left 10.

On the figures, the button 14 is formed by a localised thinning 14a of the left lateral face 10, said thinning extending in particular over the whole periphery of said button, in order to allow the activation of said button by elastic deformation, under the effect of the pressure exerted on it by a finger of the user.

The button 14 can also be formed by a localised protrusion on the lateral face 10, said protrusion being in particular able to be provided in addition to a thinning 14a as described previously.

The grille 6 is positioned in the top face 12 of the case 1, and is perforated to have a lattice of openings 7, through which the active substance of a pad 3 is intended to evaporate. These openings 7 can have varied geometries, such as for example:
a hexagonal geometry, in order to give to the grille 6 an aesthetic appearance of the “honeycomb” type (FIGS. 1a, 1b); or
a diamond geometry (FIGS. 3a, 3b, 4a, 4b).

To optimise the evaporation and the diffusion through it of the active substance contained in the pad 3, the grille 6 has a surface that forms at least 80% of the surface of the top face 12. Likewise, the openings 7 form between the housing 4 and the outside of the case 1 an air-passage cross section the area of which is greater than at least 60% of the surface of the grille 6.

According to one embodiment, the grille 6 can be produced from a metal material, in particular aluminium, and can be overmoulded by the material constituting the case 1, in order in particular to be able to position said grille as close as possible to the housing 4 to promote the evaporation of the active substance. In a variant, the grille 6 can be formed in a single piece with the case 1, in particular by moulding of said case.

The case 1 is furthermore equipped with at least one member 15a, 15b for association on the carrying element, which in particular can be formed in a single piece with said case, in order to facilitate manufacture thereof. In a variant, the case 1 can be used independently of the carrying element, for example by being laid for diffusing the active substance.

In relation to the figures, the case 1 has at least one loop 15a, 15b in which a bracelet 2 is mounted. In particular, the bracelet 2 may be of the NATO type or the loops 15a, 15b may be compatible with such a bracelet.

The bracelet 2 has in a single piece a first end 2a provided with a row of orifices 16 extending regularly over a part of its length, and a second end 2b to which a tongue 17 and a tightening buckle 18 made from rigid material, in particular metallic, are attached, the tongue 17 being arranged to be inserted selectively in an orifice 16 according to the dimension of use required for the bracelet.

In a variant, the bracelet 2 may comprise two strands each having a complementary tightening means and, opposite, a means for association with the case 1.

In the embodiments shown, the case 1 is equipped with two loops 15a, 15b spaced apart longitudinally, in particular in a direction parallel to the left 10 and right 11 lateral faces. In particular, the loops 15a, 15b may extend at least partly on the bottom face 13 of the case 1. This arrangement makes it possible to increase the dimensions of the grille 6 independently of the dimensions necessary for attaching the case 1 to the bracelet 2.

On FIGS. 1b, 2a, 2b, 3a, the loops 15a each have an oblong cross section and both extend in a direction strictly parallel to the front 8 and rear 9 lateral faces, each being separated longitudinally from the adjacent front 8 or rear 9 face.

On FIGS. 4a and 4b, the loops 15b each have a substantially circular cross section and extend from the bottom face 13 of the case 1 while projecting longitudinally from the adjacent front 8 or rear 9 face.

In a variant that is not shown, the front 8 and rear 9 lateral faces can each be equipped with a loop for associating the case 1 on the bracelet 2.

Advantageously, a bracelet 2 may be disposed reversibly in the loops 15a, 15b, which enables the user to change it easily, in particular to replace it in the case of deterioration or to select it according to their aesthetic preferences.

In particular, the bracelet 2 may be produced from various materials, in particular textiles or flexible plastic, and may have different colours and/or patterns.

1. An accessory intended to be worn by a user, said accessory comprising a case and an element for carrying said case, said accessory further comprising a pad that is able to release an active substance by gradual evaporation, the case being equipped with a housing that has a lateral slot through which said pad can be reversibly inserted, said housing being arranged to provide a force for holding said inserted pad, at least one wall of said housing having a grille the openings of which are arranged to allow the evaporation of the active substance through said grille.

2. The accessory according to claim 1, the case being produced from an elastomer material.

3. The accessory according to claim 1, the housing being elastically deformable through the insertion of the pad, said deformation being arranged so that said housing applies to the pad a clamping force that is sufficient to hold said pad.

4. The accessory according to claim 1, the grille being produced from a metal material.

5. The accessory according to claim 1, the grille being overmolded by the material forming the case.

6. The accessory according to claim 1, in that the case having a parallelepipedal geometry with rounded edges, the housing being formed between four lateral faces respectively front-rear and left-right, and two faces respectively top and bottom.

7. The accessory according to claim 6, further comprising a lateral face having a slot for introducing the pad into the housing.

8. The accessory according to claim 7, the lateral face opposite to the slot having a button making it possible to push the pad out of the housing to facilitate removal thereof.

9. The accessory according to claim 6, the grille being positioned in the top face of the case.

10. The accessory according to claim 9, the grille having a surface that forms at least 80% of the surface of the top face of the case.

11. The accessory according to claim 1, the case being equipped with at least one association member for association on the carrying element.

12. The accessory according to claim 11, the case having at least one loop in which a carrying bracelet is mounted.

13. The accessory according to claim 11, the association member being formed in a single piece with the case.

14. The accessory according to claim 1, the pad being formed by a matrix of polymer material wherein a liquid composition comprising the active substance is impregnated.

15. The accessory according to claim 1, the active substance having a repellent function that is at least one of a group including effective at repelling harmful animals, perfuming, and aromatherapeutic.
